(19) United States
(12) Patent Application Publication
(10) Pub. No.: US 2012/0179541 A1
(43) Pub. Date: Jul. 12, 2012

(54) SYSTEM AND METHOD FOR PROVIDING ADVERTISEMENT IN WEB SITES

(75) Inventors: Antti Juhani Pasila, Neitojenpolku (FI); Lars-Michaël Paqvalén, Espoo (FI)

(73) Assignee: SCENTARA OY AB, Helsinki (FI)

(21) Appl. No.: 13/005,403

(22) Filed: Jan. 12, 2011

(51) Int. Cl. G06Q 30/00

(52) U.S. Cl. 705/14.49; 705/14.71

(57) ABSTRACT

Embodiments of the invention are concerned with showing information such as advertisements in website pictures. Advertisements are shown in web site as some of the embedded pictures in the web site are hovered. According to embodiments advertisements can be related to content of such hovered pictures such as products shown in the pictures.

### FIELD OF THE INVENTION

The present invention relates generally to providing additional information on digital objects such as pictures in web pages. Example of additional information according to some embodiments is advertisements related to product and services presented in pictures or videos within website content.

### BACKGROUND OF THE INVENTION

Internet is used widely to find and access information. Number of web sites globally can be estimated to be billions. Typically web sites contain information such as text, pictures, videos, audio etc. Rationale and motivation to set up a web site depends on person, organization or company that is setting up the site.

Companies such as retailers set up web sites mainly in order to provide consumers information about their products and services. One example of such web site is web page of computer manufacturer Apple® (http://www.apple.com) where the web site contains information about new products (computers, iPods, iPhones) as well as applications (software) which is available for sale. Site provides information for consumer either on where is the closest retail shop and in addition it provides consumers possibility to purchase goods on line using payment methods like credit card or bank payment. Other examples of web site set up in order to sell goods and services to consumers include Amazon® (http://www.amazon.com) for purchasing books (real and electronic) and Hotels.com (http://www.hotels.com) for selecting and booking hotel rooms globally. Many of these companies with product or service want more consumers to visit their site and ultimately purchase the product or the service. One method for getting more consumers to site is means of advertisement in other web sites.

There are organizations and companies that are in business of providing information such as news for consumers. One example of such web site is news web site of CNN® (http://www.cnn.com) a web site of global news channel CNN. The site contains information of breaking news and other news locally and globally. Other examples of web sites for providing information include video web sites like YouTube® (http://www.youtube.com) for consumers to access (and share) videos. Additional examples of web services are social network sites such as Facebook (http://www.facebook.com) for consumers to discuss and share information with their peer groups and Google (http//www.google.com) for providing search services for consumers. The business rationale for above companies running sites of above examples is mainly advertisement driven i.e. web site owner makes money by presenting advertisements to consumers who visit the site. Money is typically generated when advertisement is shown (pay per view), when a link in the advertisement is clicked (pay per click), or when interaction with advertisement results on sales (pay per results).

Problem with said advertisement methods is that it is often found irrelevant or annoying for consumers. Main reason to visit site is in the end of the day anyway to get to see content of the site not the advertisements.

Prior art U.S. Pat. No. 7,003,734 describers an advertisement type where a banner advertisement includes “pop up” areas. In such advertisement additional information in form of text, picture, video or other html content is presented to user when user hover with mouse over banner advertisement. Problem with prior art is that it requires publisher web site (such as CNN.com) to host some of the images and other date related to pop up in order to overcome limitations in Javascript object model prohibiting cross domain interaction or to host publisher content at advertisement provider domain.

### SUMMARY OF THE INVENTION

In accordance with aspects of the present invention, there is provided a method and system according to the appended independent and depended claims.

At least some embodiments of the invention provide a method for creating advertisements to be presented in a pop up frame in a web site. Said method comprises of storing in a database advertisement contents from plurality of advertisers, at least some of the advertisers being store owners and some of the advertisers being product owners. Store owners and product owners can store in database bid information relating to advertisement content. Bid information related to advertisements can consists of a first bid amount, the first bid amount being set by a store owner and defining specific a bid amount related to the store owner, and a set of second bid amounts, the set of second bid amounts being set by a store owner and defining bids allocated to plurality of products or product owners, and the bid information relating to advertisements of product owners comprising a third bid amount, the third bid amount being set by a product owner and defining bid amounts allocated to plurality of products. A request for an advertisement to be displayed in the pop up frame relating to a hovered product can be received by advertisement service and advertisement is created by selecting and combining an advertisement of a product owner and an advertisement of a store owner. Selecting can be based on comparing sum of the first, second and third bid amounts of bids set by store owners and product owners of which the second and third bid being allocated to the hovered product.

Additionally in web page with text and at least one picture or video are stored on a server and the picture has been associated with a product has designated area which trigger a pop up frame to be displayed when hovered with mouse or other pointing means such as touch screen.

Additionally owner of the picture can set association of a pop up frame i.e. define for example product information relating to the picture content. As picture is shown in target web site and a hovering is recognized an advertisement is created. According to embodiments store owners sets a separate second bids associated to different product owners or products. Advertisement content can comprise universal resource locator (URL).

In some embodiments the website reputation is checked prior selecting the advertisement content to the created advertisement. Reputation can be checked using data stored to a server which collects users' experience on web sites in world wide web (www-sites).

Additionally if the URL directs first to third-party tracking services, which record a user's click and then redirects the user to a content owner's website or to a store owner's website, the reputation of the site the user is redirected can be checked.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic diagram showing an environment in which an embodiment of the invention can operate.

FIG. 2 is a schematic picture of some elements in a web site;

FIG. 3 shows example tagbubble i.e. pop up frame with advertisement.

FIG. 4 is a schematic flow diagram showing some steps of defining advertisement area and activating tagged picture.

FIG. 5 shows some message flows in an environment in which an embodiment of the invention ca operate

FIG. 6 shows an example business model and revenue flows according to an embodiment of the invention

FIG. 7 shows some example database structures in embodiments of the invention.

FIG. 8 shows example environment of accessing some web services.

FIG. 9 shows example usage flows of some embodiments of the invention.

### DETAILED DESCRIPTION OF THE INVENTION

As described above, embodiments of the invention are concerned with improving efficiency of performing acceptance and relevancy of advertisements and other additional information in web pages.

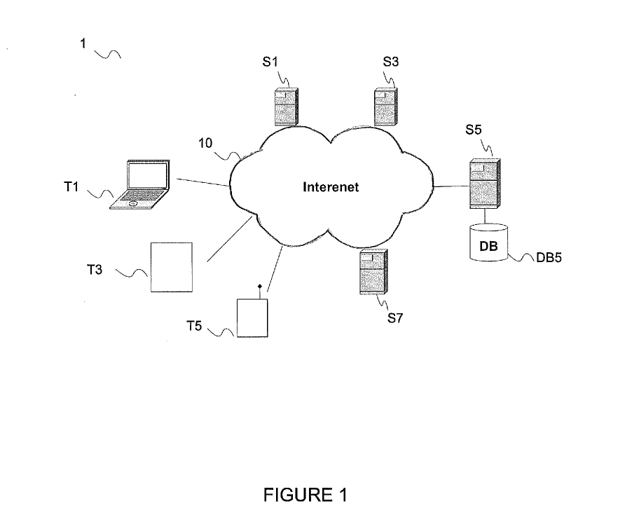

FIG. 1 shows high-level architecture of the environment where embodiments of the invention can work. The system 1 comprises of Internet 10, user terminals T1, T3, T5, service provider servers S1, S3, S7, advertisement service provider S5 and databases such as DB5. Terminals T1, T3 and T5 can be any user terminals such as personal computers (PC), laptops, web pads such as Apple iPads, mobile terminals such as mobile phones, smart phones, iPhones etc. Terminals can be connected to Internet via any available connection method. Typically for example mobile terminal (T5) is connected to Internet 10 using cellular connectivity such as 3rd generation (3G) network. Terminals like web pads (T3) are often connected to Internet 10 via Wireless local area network connection (WLAN) and personal computers often using wired communication such as Digital Subscriber Line (DSL). Terminals T1, T3, T5 typically contain web browser such as Safari™, Firefox™, Internet Explorer™, Chrome™ etc for enabling to render web content in the terminal using known methods. Service provider servers S1, S3 and S7 are hosting web site for users to access via Internet 10. Servers S1, S3, S7 might have Apache™ web server software which is used to host actual web content. Web content can be for example HTML (Hypertext mark up language), XHTML (Extended Hypertext mark up language), PHP (Hypertext preprocessor), Java™ etc including text, videos, pictures, audio and other digital content. Advertisement service server S5 can be implemented in top of for example Apache web server or other known server architecture. There can be database DB5 included in advertisement service infrastructure. Database DB5 can be for example Oracle™, MySQL or any other database.

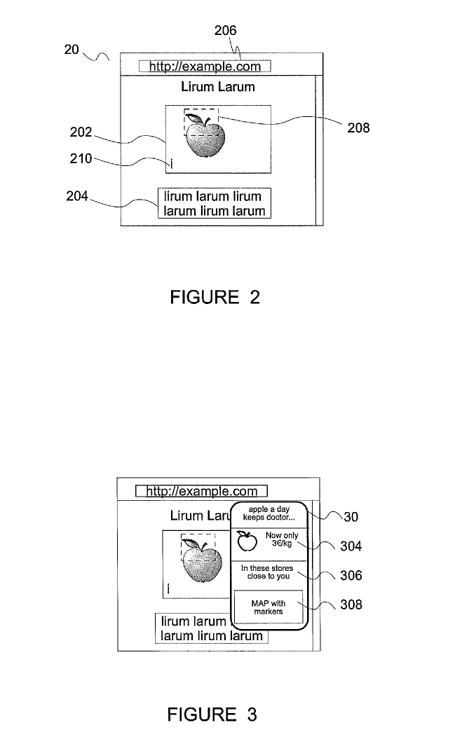

In one embodiment of the invention there is web content in web service S1, S3 or S7. An example of the service is web page with text 204 and pictures 202 as shown in FIG. 2. FIG. 2 shows a typical browser 20 view. Browser 20 has field 206 for inputting URL (Universal Resource Locator) such as http://example.com. The page is rendered in browser using fetched source code (html, php etc). Page can have for example text 204 and pictures 202. According to embodiment of the invention a picture 202 has designated area(s) 208 which trigger popup frame to be displayed when hovered with mouse or other pointing means such as touch screen. Picture 202 might have indication in the picture that there is such areas by either highlighting the area 208 or for example visual indication 210 in the corner of picture that picture contains designated area or areas 208. As consumer hovers mouse over the area 208 a pop upframe (referred as Tagbubble later) 30 is displayed in top of the information content of the web page as shown in FIG. 3. Tagbubble 30 can include information like text 306, pricing etc information about the product 304 and for example a map 308 to find stores to purchase the product advertised in the Tagbubble 30. Tagbubble 30 can contain any HTML code and can include pictures, videos etc any digital items. Tagbubble 30 can contain clickable items such as URL's to get more info either in the Tabbubble 30 or in to direct to other web site.

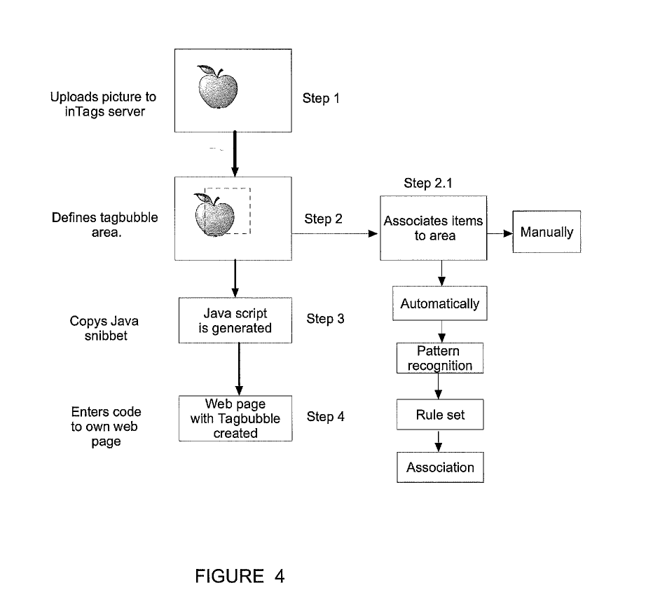

A content (picture, video) owner can associate tagbubble 30 to his content by accessing advertisement service server S5 via web interface over Interent 10. FIG. 4 shows some steps of said association. In Step 1 content owner uploads figure to server S5 or database DB5. Using web based user interface (UI) the content owner defines area in the picture where he/she wants to associate additional information (Step 2). User might define also which information such as product attribute, available stores, pricing, preferred advertisement types, price for advertisement placement in the picture, preferred brands to be associated with the picture, preferred products and services to be associated with the picture in Step 2.1. In one embodiment this is done automatically using pattern and/or picture recognition techniques. Picture would be scanned to for example recognize brands or products or logos or trademarks visible in the tagbubble area (208). Said brands and/or products would be associated with the tagbubble area and stored in the database DB5 of advertisement service using rule set. Information related to product can be also European Article Code (EAN) or similar standardized product code. The step 2.1 can take place also later. In Step 3 advertisement service server S5 generates Javascript snipped code for content owner to copy and paste (Step 4) to the code of his web service in desired location. Said Html (php etc) code would now include a code snippet <img . . . /xxx/xxx.com . . . >< . . . /123324.js> in those places where picture 202 with tagbubble 208 is purposed to be. <img . . . > attribute fetches picture to web site from specified network location. In preferred implementation the picture 202 is in same server as tagbubbles but the invention is not limited to this. Picture can be in any server including content owners own web site or other 3rd party web site. In an other embodiment generated code is copied and pasted (Step 4) by other than content owner, for example web service owner such as CNN.com, in order to embed said content to web site of third party.

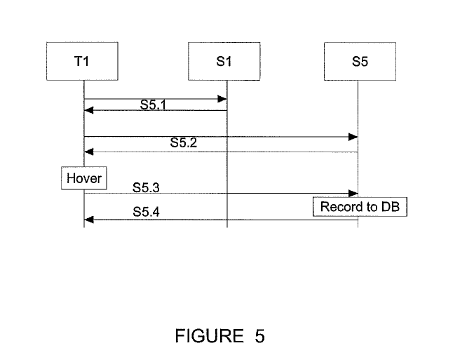

One key element in providing advertisement services or other services using pop ups is monitoring if hovering has taken place or not. Said monitoring can be used as basis for billing for the services. FIG. 5 illustrates an embodiment where a user of terminal T1 is in web site hosted by service provider server S1. In step S5.1 browser fetches web content from the site. Content can include Javascript snippet created as described earlier. In one embodiment of the invention Java script is located in different domain (in server S5) than actual web page (which is in server S1) that is requesting the Java script. Tagbubble 30 is constructed preferably in server system S5 as dynamic java script. In step S5.2 said Java script is downloaded to user terminal T1. Java script is called as the hovering takes place i.e mouse or other pointing means is used over the picture as discussed earlier. Since there are certain security related reasons in Java typically the script can not inform about the hovering to other domain (S5) than where the actual target web site (S1) is. This can be overcome with an embodiment of having in the Java script a call for preferably 1×1 pixel image from server S5. As an example there could be code such as http://server_S5.com/show-pic/some-info/<ID12345>/other-info/<inlocationXYZ>/file/a.jpg. Which is called by browser in step S5.3. As the server S5 gets request for file a.jpg it can store in the database DB5 time, date, browser related info, Internet Protocol (IP) address, location information etc. In addition there can be some parameters embedded in the URL (universal resource locator) such as unique ID (ID12345 in example code) to identify which generated Java snippet was hovered, which picture was hovered which part of the picture was hovered etc. There could be also other info such as location info of the user etc. Server S5 would return to browser file a.jpg which would render it normally.

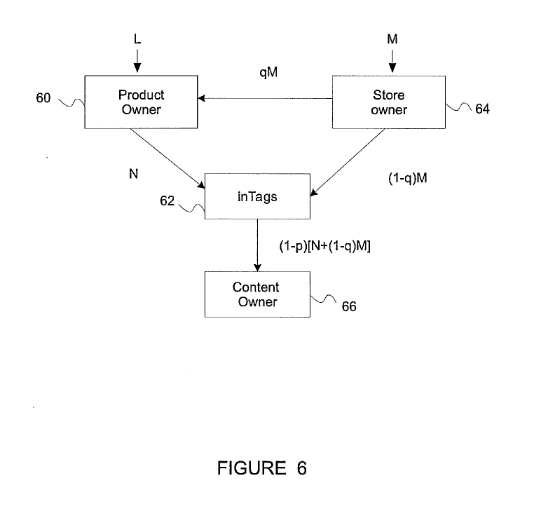

According to embodiment of invention new novel business model is enabled as shown in FIG. 6. Parties involved in the example are “in Tags” 62 i.e. company running tagbubble service i.e. hosting/managing/operating servers S5 and database DB5. 66 “content owner” i.e. party, person owning certain or all copyrights for the pictures to be shown in any participating web site. Content owner can be thus individual or it can be for example some picture storage service such as Flikr.com. Store owner 64 refers to owner of “real store” with facilities for customer to visit (such as Tesco in UK or WalMart in US) or virtual store i.e. web shop such as amazon.com. Registered storeowners can have their physical location i.e. address stored in database DB5. In some cases store owners carry multiple brands and multiple products of multiple brands. In some cases stores can be limited to certain brands and/or products. Product owner 60 refers to owner of brand name of the product or manufacturer of the product such as Nike™ for shoes and other sporting goods or as Apple™ for computers, software, applications and phones.

Store owners 64 and product owners 60 can register in intags service 62. When registering to the service store owners 64 can upload information on which products they carry, related availability (inventory) information, pricing information and store location and business hours information to mention few. Store owners can also define budget (allocation of funds of M) for presenting their information in possible tagbubble. Budget can be based on per view, per click, per action etc, it can have daily limits and there can be variable pricing on actions. In one embodiment store owner can decide which part of allocated funds M is divided between intags 62 and product owner 60. For example store owner can allocate q=30% of the funds to store owner and (100%-q)=70% to go to in Tags 62. Allocation can be also defined by advertisement service provide. Allocation q can be dynamic i.e. it can vary depending on business rules. The allocation can also be different for different product store owner pairs. This is beneficial in business since in one embodiment tagbubble 30 is generated from unique product code information basis (such as EAN code). The product code is used to get as primary information about the product from product owner 60. By allowing store owner to allocate some of it's funds to product owner it gets to influence on which products are more visible in the advertisements. This helps product owner 60 for example in situation where it has overstock of certain products. Additionally store owners can define in the database which product (EAN codes) they carry enabling mapping of which stores carry which products.

Product owner 60 can define attributes for the products and services it is offering for consumers. It can also define budget N that it desires to use to promote goods and services. The money for the budget N comes either entirely from store owners (several store owners carrying the product) or product owner can deposit in system own funds as well (L) i.e. N can be L+qM (where qM should be understood to be sum of q₁M₁+q₂M₂, . . . +qₙMₙ where index indicates ID of store owner contributing to product owner 60).

As picture with tagbubble is hovered both product owner and storeowner are invoiced depending on set parameters. According to some embodiments invoicing might take place after clicking shown advertisements instead or in addition to impression based invoicing. Revenues to advertisement service provider 62 would be N+(1−q)M on each action. Service provider 62 can share part of the revenue associated with content owner i.e. one who has provided with picture. Content owner could get (1−p)(N+(1−q)M)) of the revenues where p is revenue share percent for example 50%. Described business model embodiment enables to generate revenues from multiple sources and it will open new revenue opportunities for content owners. As an example freelance type of photographer could now offer any of the pictures for free to any web site owner such as CNN. When CNN embeds picture in the site it would include said tagbubble Java code snippet. Every time a user goes to CNN site and hovers over the picture (from freelancer) freelancer would get some revenues. There would be no need for CNN to pay royalties on the said picture (although they could). In further embodiments some of the revenues could be shared back to target web site (such as CNN). In one embodiment tagbubble shows product name such as Nike (if there is for example Nike shoe associated with tagbubble) and then info (map, name, phone number, click to call phone number, URL) of store owner which is giving largest share of allocated funds i.e qM is highest.

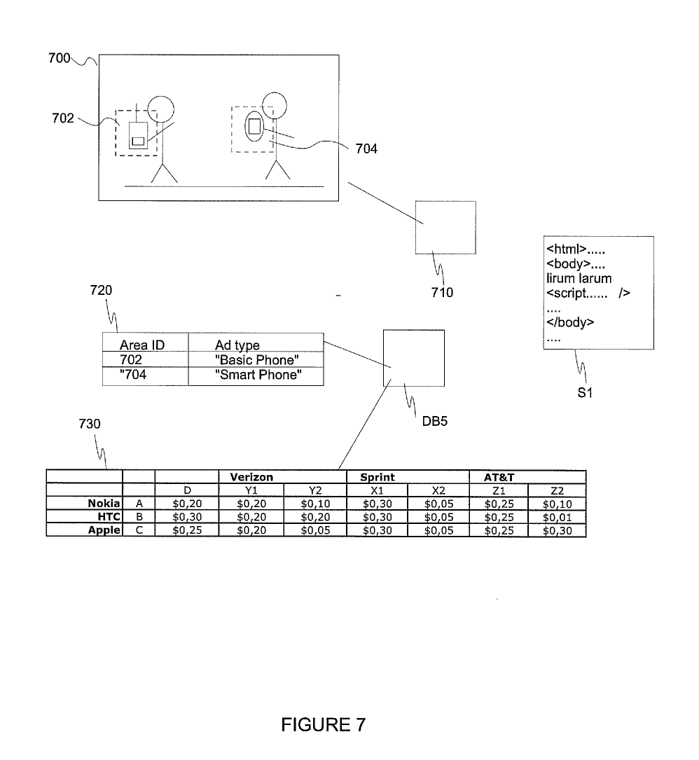

As an example embodiment advertisement to be presented in a pop up frame in a web site is created as show in FIG. 7. There is picture 700 with areas 702 and 704 defined as advertisement pop up areas (tagbubble pop up) with associated ad types as shown in table 720 stored in database DB5. In this example area identification (AreaID) 702 is associated with product category “Basic phone” referring to so called low end phone with basic phone functionality and perhaps low price point phone and AreaID 704 is associated with product category “Smart phone” referring to so called high end phone such as smart phone with touch screen, navigation etc. Associations can be done by content (picture) owner, by community, by advertisement service provider or other third party or automatically.

Database DB5 further contains advertisement content from plurality of advertisers such as phone manufactures Nokia, HTC and Apple (being in this example product owners) and telecom carriers (operators) Verizon, Sprint and AT&T (being in the example store owners). Advertisements could be for example logo of the company and/or some text and/or video and/or picture and/or link to desired target site of the advertiser.

Each advertiser can set (preferably via secured web interface) bid information relating to the advertisement content. In example of FIG. 7 there is database entry 730 in database DB5. Store owners can set plurality of different bid amounts. For example two as shown in FIG. 7; first one relates to price per action store owner is willing to pay for being shown in the web hovering case. Second bid amount is amount of money allocated to product owner. These are designated in 730 as X1, X2, Y1, Y2 and Z1, Z2 respectively. Product owners bids for their products is shown in column D of the table 730.

When end user access web service running in server 51 hovers over advertisement area 702 or 704 of picture 700 a request of showing pop up advertisement related to hovered area is received by advertisement server system S5. As an example if end user hovers over area 704 “Smart phone” related advertisement will be shown to end user browsing the web site S1 with for example HTML content. For this example it is assumed that phones from HTC and Apple are so called “Smart phones”. Now according to embodiment table 730 is used to calculate which advertisement combination of Apple+(Verizon or Sprint or AT&T) or HTC+(Verizon or Sprint or AT&T) gives highest price for advertisement provider. Related amounts are:

Apple+Verizon=>$0.25+$0.2+$0.05=$0.5

Apple+Sprint=>$0.25+$0.3+$0.05=$0.6

Apple+AT&T=>$0.25+$0.25+$0.3=$0.8

HTC+Verizon=>$0.3+$0.2+$0.2=$0.7

HTC+Sprint=>$0.3+$0.3+$0.05=$0.65

HTC+AT&T=>$0.3+$0.25+$0.01=$0.56

Where the highest combination is Apple+AT&T resulting to shown in pop up ad of Apple product related advertisement 304 combined with AT&T store owner related advertisement 306. As benefit of the described model is that store owners can control which products they are associated with. For example in this example AT&T gets ad together with Apple due to allocated funds to product owner (in column Z2). In other words an advertisement is created by selecting and combining an advertisement of a product owner and an advertisement of a store owner, the selecting being based on comparing sum of the first, second and third bid amounts of bids set by store owners and product owners of which the second and third bid being allocated to the hovered product.

In other example end user hovers over area 702 of picture 700. The area 702 is defined as low end phone. As Nokia is only low end phone in an example in database it is evident that Nokia advertisement will be shown. According to embodiments of the invention other part i.e store owner part of the advertisement is calculated by adding to Nokia bid $0.2 First bids by each store owners (carriers) Verizon, Sprint and AT&T and their respective bids to product owner as well i.e.

Nokia+Verizon=>$0.2+$0.2+$0.1=$0.5

Nokia+Sprint=>$0.2+$0.3+$0.05=$0.55

Nokia+AT&T=>$0.2+$0.25+$0.1=$0.55

Giving as highest $0.55 for two combinations. Sprint or AT&T could be selected as round robin, randomly or according to looking on for example second bid i.e. column X2 and Z2 i.e. funds allocated to product owner. As AT&T is allocating most funds to Nokia it could be determined to be winner i.e combination of Nokia+AT&T advertisement would be shown in pop up frame.

Further according to embodiments of the invention allocated second bids i.e. Y2, X2 and Z2 columns in table 730 are not given as direct revenues to advertisement provider but are allocated as additional funds to product owner. This is particularly beneficial from product owner point of view due to lowering their advertisement budget. If product of product owner is such that all store owners want to be associated with there can be situation where product owner does not have to allocated funds at all or it can make money by allocations.

In a further embodiment selection of which advertisements to be shown can be done by using alternative measurements such as user preferences, location of user, location of user in respect to store owner facilities physical location, randomly, in round robin style etc. This is particularly beneficial in case of two or more bid information/amounts being same.

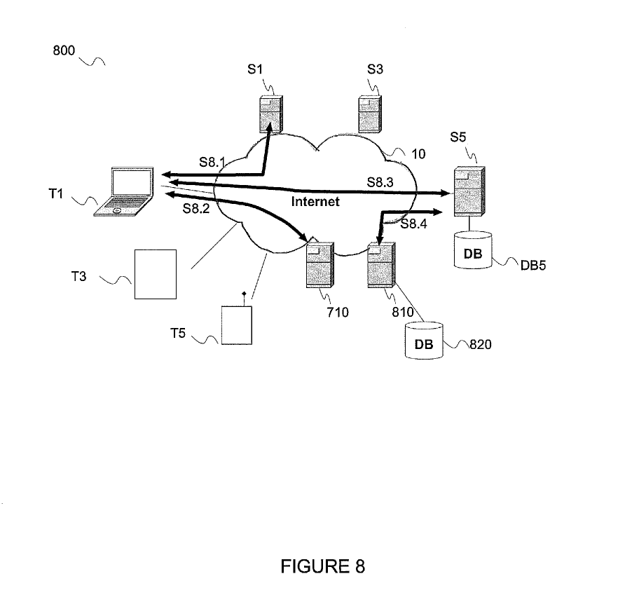

A further embodiment of the invention is shown in environment of FIG. 8. Terminals T1, T3 and T5 are capable of accessing information over Internet 10 from various web service and servers. As an example user of laptop T1 browses to web site hosted in server S1 in step S8.1. There is code embedded in code as described earlier thus browser of laptop T1 downloads from picture owners server 710 in step S8.2 and renders it accordingly. As the user hovers over the picture advertisement provider server S5 is contacted in step S8.3. According to further embodiment advertisement provider contacts web service rating server 810 to get information if the site (in S1) qualifies as appropriate site to show advertisements of product owner or store owner as shown in step 8.4.

An example of such service could be Web on Trust (http://www.mywot.com) service where consumers rate web sites as they visit those. As the server S5 contacts server 810 it runs check on the database 820 for rating information on site S1. Additionally rating/trust service 810 could provide information on reliability or reported reliability of store owner which wants to advertise in the system. Trust server would return information to advertisements service S5 in step S8.4. Advertisement server would now decide in addition to business rules on which product owner and store owner to promote in the site if to promote any or only some store owners or some product owners. This is particularly important since for example product owners could define in trust server 810 database 820 some stores are not wanted by them to sell their products or could prefer one store over an other.

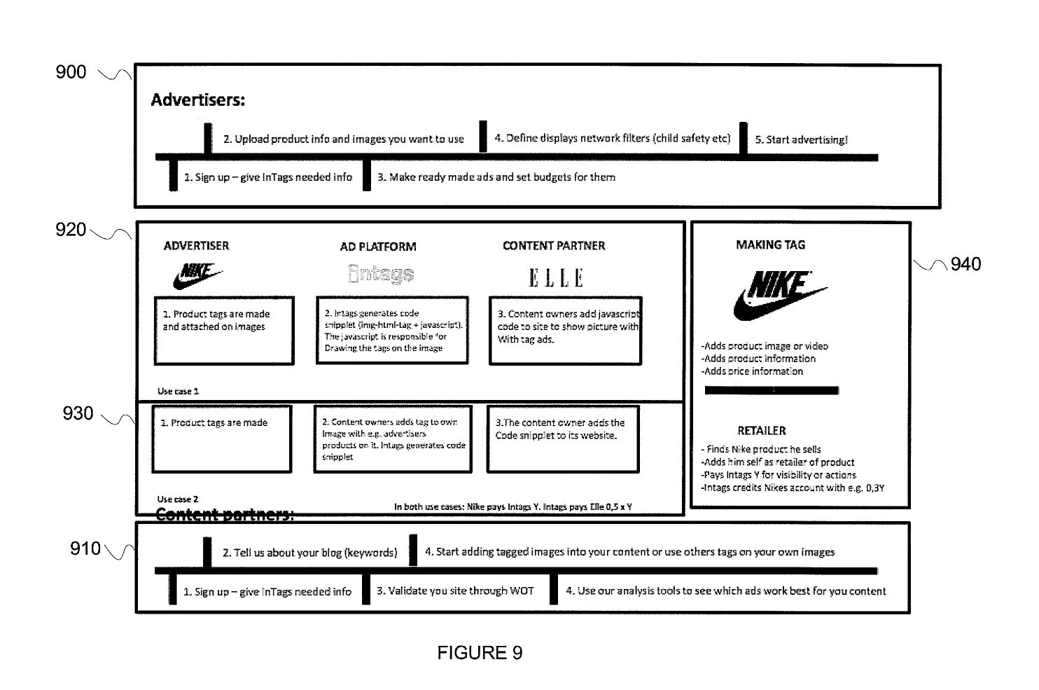

Additional examples of embodiments of the invention are shown in FIG. 9. Box 900 shows steps for advertiser to start advertising with advertisement service provider (example Intags™ as advertisement service provider). In step 1 advertiser such as product or store owner signs up for service and provides basic info as name of advertiser, billing details etc. In step 2 advertiser uploads product info and images for the advertisement(s). In step 3 advertiser can use existing advertisement templates or use advertisements it has created. Advertiser set up advertisement budget. In step 4 advertiser can set up network filters such as defining which sites and on which type of pictures advertisements can be shown. In Step 5 advertisement campaign is started.

Box 910 of FIG. 9 shows some steps on how content partner (i.e. web site owner such as cnn.com) can use embodiments of the invention. In step 1 content partner signs up for service i.e provides name and other info. In step 2 information about content service such as blog or other web service is set to the system (keywords, tags etc). In step 3 site reputation score is allocated by validating (submitting) the site also to ranking service or reputation service such as Web on Trust 810. In step 4 content partner (web site owner) can start adding tagged images (in practice code snippets) in the web site or it can start to us other tags in own images. Content partner can use analysis tools of advertisement service provide to see which ads are performing best.

In box 920 of FIG. 9 a use case 1 is shown as three steps. In step 1 advertiser Nike® (product owner) makes product tags on some of the images in the service. In step 2 Intags generates code snippets (img-html-tag+javascript). The javascript is responsible for drawing the tags on the image. In step 3 content owner (ELLE®) adds javascript code to the site showing picture with tag ads (tabb bubble or pop up frame). Now ELLE® (www.elle.fi) can show in their web site Nike product related pictures with Nike advertisements and tags.

In box 930 of FIG. 9 a use case 2 is shown as three steps. In step 1 advertiser makes product tags. In step 2 content owners adds tags to own image with e.g. advertisers product on it. Intags generates code snippets. In step 3 content owner adds the code snippet to its website.

In box 940 of FIG. 9 a flow of making tags (pop up frames) is shown. Product owner such as Nike® adds product image or video, adds product information and adds price information of the product to server S5 (and in database DB5 of). Retailer (store owner) finds from database DB5 Nike products he is selling. Retailer adds him self as retailer of said product and pays for Intags for visibility or actions (Y or M as in FIG. 6). Intags credits Nike account with specified ratio e.g. 0.3xY (i.e. q=30% as in FIG. 6).

The above embodiments are to be understood as illustrative examples of the invention. It is understood that any feature described in relation to any one embodiment may be used alone, or in combination with other features described, and may also be used in combination with one or more features of any other of the embodiments, or any combination of any other of the embodiments. Additionally some of the embodiments with certain steps can be executed in any order by any party. Some of the steps might not be needed in all cases of implementing the invention. Furthermore, equivalents and modifications no described above may also be employed without departing from the scope of the invention, which is defined in the accompanying claims.

1. A method for creating an advertisement to be presented in a pop up frame in a web site, the method comprising:
storing in a database advertisement contents from plurality of advertisers, at least some of the advertisers being store owners and some of the advertisers being product owners,
storing in the database bid information relating to advertisement contents,
the bid information relating to advertisements of store owners comprising a first bid amount, the first bid amount being set by a store owner and defining specific a bid amount related to the store owner, and a set of second bid amounts, the set of second bid amounts being set by a store owner and defining bids allocated to plurality of products or product owners, and
the bid information relating to advertisements of product owners comprising a third bid amount, the third bid amount being set by a product owner and defining bid amounts allocated to plurality of products,
receiving a request for an advertisement to be displayed in the pop up frame relating to a hovered product,
creating an advertisement by selecting and combining an advertisement of a product owner and an advertisement of a store owner, the selecting being based on comparing sum of the first, second and third bid amounts of bids set by store owners and product owners of which the second and third bid being allocated to the hovered product.

2. A method according to claim 1, wherein a web page with text and at least one picture are stored to a server and the picture has been associated with a product has designated area which trigger a pop up frame to be displayed when hovered with mouse or other pointing means such as touch screen.

3. A method according to claim 2, wherein an owner of the picture sets association of a pop up frame.

4. A method according to claim 2, wherein during association of the picture product information relating to the picture content is stored to the database.

5. A method according to claim 1, wherein web page browsing is monitored to recognize hovering of the designated area and when hovering is recognized, the request for an advertisement is created.

6. A method according to claim 1, wherein a store owner sets a separate second bid for different products.

7. A method according to claim 1, wherein a store owner sets separate second bids associated to different product owners.

8. A method according to claim 1, wherein advertisement content comprises a Uniform Resource Locator (URL).

9. A method according to claim 8, wherein website's reputation is checked prior selecting the advertisement content to the created advertisement.

10. A method according to claim 9, wherein the site's reputation is checked using data stored to a server which collects users' experiences of www-sites.

11. A method according to claim 10, wherein if the URL directs first to third-party tracking services, which record a user's click and then redirects the user to a content owner's website or to a store owner's website, the reputation of the site the user is redirected checked.

12. An advertising system for creating an advertisement to be presented in a pop up frame comprising:
a database for storing advertisement contents from plurality of advertisers, at least some of the advertisers being store owners and some of the advertisers being product owners,
a bid database for storing bid information relating to advertisement contents,
the bid information relating to advertisements of store owners comprising a first bid amount, the first bid amount being set by a store owner and defining specific a bid amount related to the store owner, and a set of second bid amounts, the set of second bid amounts being set by a store owner and defining bids allocated to plurality of products or product owners, and
the bid information relating to advertisements of product owners comprising a third bid amount, the third bid amount being set by a product owner and defining bid amounts allocated to plurality of products,
an advertisement creator arranged to create an advertisement by selecting and combining an advertisement of a product owner and an advertisement of a store owner, the selecting being based on comparing sum of the first, second and third bid amounts of bids set by store owners and product owners of which the second and third bid being allocated to the hovered product.

13. An advertising system according to claim 12, wherein the system comprises a server arranged to store web content of a web page with text and at least one picture and a database to store association information of a picture associated with a product, and data relating a designated area in the picture, the data being arranged to trigger a pop up frame to be displayed when designated area is hovered with mouse or other pointing means such as touch screen.

14. A system according to claim 13, wherein the system comprises an interface to enable an owner of the picture to set association of a pop up frame.

15. A system according to claim 12, wherein the server is arranged to monitor the web page browsing to recognize hovering of the designated area and when hovering is recognized, the server is arranged to create the request for an advertisement.

16. A system according to claim 12, wherein the bid database comprises plurality of bid categories arranged to enable a store owner to set a separate second bid for different products.

17. A system according to claim 12, wherein the bid database comprises plurality of bid categories arranged to enable a store owner to set a separate second bids associated to different product owners.
